(19) United States
(12) Patent Application Publication
(10) Pub. No.: US 2015/0373571 A1
(43) Pub. Date: Dec. 24, 2015

(54) Scheduling Fractional Frequency Gaps To Enable Sub Band Sensing

(71) Applicant: INTERDIGITAL PATENT HOLDINGS, INC., Wilmington, DE (US)

(72) Inventors: Amith V. Chincholi, Sunnyvale, CA (US); Joseph M. Murray, Schwenksville, PA (US); Alpaslan Demir, Melville, NY (US); Tam B. Le, New York, NY (US); Jean-Louis Gauvreau, La Prairie, CA (US); Janet A. Stem-Berkowitz, Little Neck, NY (US)

(73) Assignee: InterDigital Patent Holdings, Inc., Wilmington, DE (US)

(21) Appl. No.: 14/764,260

(22) PCT Filed: Jan. 29, 2014
(86) PCT No.: PCT/US2014/013584

§ 371 Date: Jul. 29, 2015

Related U.S. Application Data
(60) Provisional application No. 61/758,109, filed on Jan. 29, 2013.

(51) Int. Cl. H04W 24/10; H04W 24/08; H04L 5/00; H04W 72/04; H04W 16/14

(52) U.S. Cl. CPC H04W 24/10; H04W 72/044; H04W 16/14; H04L 5/0007; H04W 24/08

(57) ABSTRACT

Systems, methods, and instrumentalities are disclosed for scheduling fractional frequency gaps (FFGs). A wireless transmit/receive unit (WTRU) may receive an FFG type, an FFG pattern, a filter type, and/or a sensing metric. The WTRU may transmit a sub-band identifier, a sensing metric value, and/or an event report. The FFG type may indicate a sub-band sensing type. The FFG pattern may indicate a sub-band gap. The filter type may indicate the sub-band spectral filter type. The sub-band identifier may indicate the identity of the sub-band gap. The sensing metric may indicate a metric value corresponding to the sub-band identifier. The event report may indicate an identifier of a measurement report.

### CROSS-REFERENCE TO RELATED APPLICATION

This application claims the benefit of U.S. Provisional Patent Application No. 61/758,109, filed Jan. 29, 2013, the disclosure of which is hereby incorporated in its entirety.

### BACKGROUND

Multi-carrier systems, e.g., long term evolution (LTE) and LTE Advanced (LTE-A) may use underutilized license exempt (LE), unlicensed, and/or shared bands to meet high bandwidth demands. Various mechanisms, including, for example, sensing may be used to take advantage of the LE bands and provide high bandwidth. However, the sensing mechanisms provided may not be adequate.

A wireless transmit/receive unit (WTRU) may report inter-RAT and/or inter-frequency measurement information in accordance with a measurement configuration as provided, for example, by an eNodeB (eNB). An eNB may provide a measurement configuration that may be applicable for a WTRU using, for example, a connection reconfiguration message. Such a message may include information relating to measurement gaps, which may specify time periods that a WTRU may use to perform inter-RAT and/or inter-frequency measurements with no transmissions scheduled for it during such time periods.

### SUMMARY

Systems, methods, and instrumentalities are disclosed for implementing scheduling of a fractional frequency gap (FFG). A wireless transmit/receive unit (WTRU) may receive an FFG type, an FFG pattern, a filter type, and/or a sensing metric. The WTRU may transmit a sub-band ID, a sensing metric, and/or an event report. The FFG type may indicate a sub-band sensing type. The FFG pattern may indicate the number of physical resource blocks (PRBs) in a sub-band gap. The filter type may indicate the sub-band spectral filter type.

The sub-band ID may be transmitted from the WTRU and may indicate an identity of the sub-band gap. The sensing metric may indicate a metric value corresponding to the sub-band ID. The event report may indicate an ID of a measurement event.

A wireless transmit/receive unit (WTRU) may perform sensing on a portion of a frequency band by receiving a fractional frequency gap (FFG) pattern indicating a sub-band of the frequency band and an associated time interval. The WTRU may perform sensing on the sub-band during the time interval indicated by the FFG pattern. The WTRU may send a measurement report comprising a sub-band identifier identifying the sub-band and a sensing metric indicating a metric value corresponding to the sub-band identifier.

An eNodeB may comprise a processor configured to select fractional frequency gap (FFG) patterns indicating sub-bands of a frequency band and respective associated time intervals and to sequentially silence the sub-bands during the time intervals indicated by the FFG patterns.

### BRIEF DESCRIPTION OF THE DRAWINGS

FIG. 1A is a system diagram of an example communications system in which one or more disclosed embodiments may be implemented.

FIG. 1B is a system diagram of an example wireless transmit/receive unit (WTRU) that may be used within the communications system illustrated in FIG. 1A.

FIG. 1C is a system diagram of an example radio access network and an example core network that may be used within the communications system illustrated in FIG. 1A.

FIG. 1D is a system diagram of another example radio access network and another example core network that may be used within the communications system illustrated in FIG. 1A.

FIG. 1E is a system diagram of another example radio access network and another example core network that may be used within the communications system illustrated in FIG. 1A.

FIG. 2 illustrates by example primary user (PU) detection in television white space (TVWS) using sub-band sensing.

FIG. 3 illustrates example channel coherence blocks in an orthogonal frequency division multiplexing (OFDM) based multi-carrier system.

FIG. 4 illustrates example fractional frequency gap patterns in a deterministic approach.

FIG. 5 illustrates example fractional frequency gap patterns in an opportunistic approach.

FIG. 6 illustrates example fractional frequency gap patterns in a hybrid approach.

FIG. 7 illustrates by example spectral power ramp up in an active sub-bands approach.

FIG. 8 illustrates example spectral shaping over an active sub-bands approach.

FIG. 9 illustrates example guard bands between active and silent sub-bands.

FIG. 10 illustrates an example signaling process in a deterministic approach.

FIG. 11 illustrates example measurement signaling parameters in a deterministic approach.

FIG. 12 illustrates example sub-band measurement events at a WTRU.

FIGS. 13A-13B illustrate example control signaling in an opportunistic approach.

FIG. 14 illustrates example measurement signaling in an opportunistic approach.

FIG. 15 illustrates example frequency gap patterns in a dual approach.

FIG. 16 illustrates an example throughput comparison of a temporal gap approach with an FFG approach.

FIG. 17 illustrates an example throughput gain with FFG with respect to temporal gaps for a given sensing duty cycle.

### DETAILED DESCRIPTION

A detailed description of illustrative embodiments will now be described with reference to the various Figures. Although this description provides a detailed example of possible implementations, it should be noted that the details are intended to be exemplary and in no way limit the scope of the application.

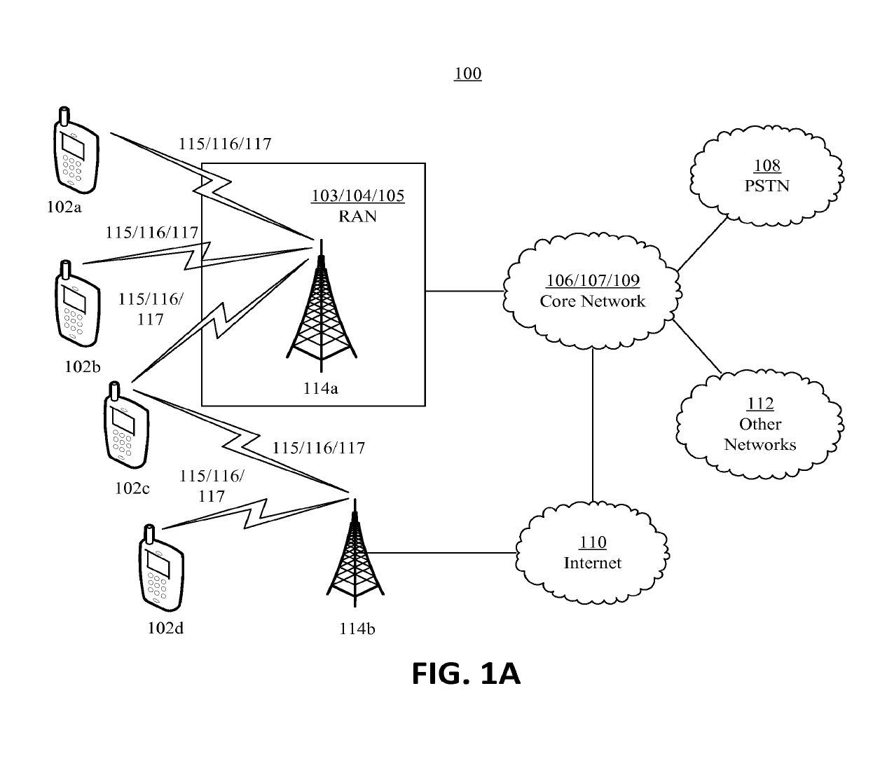

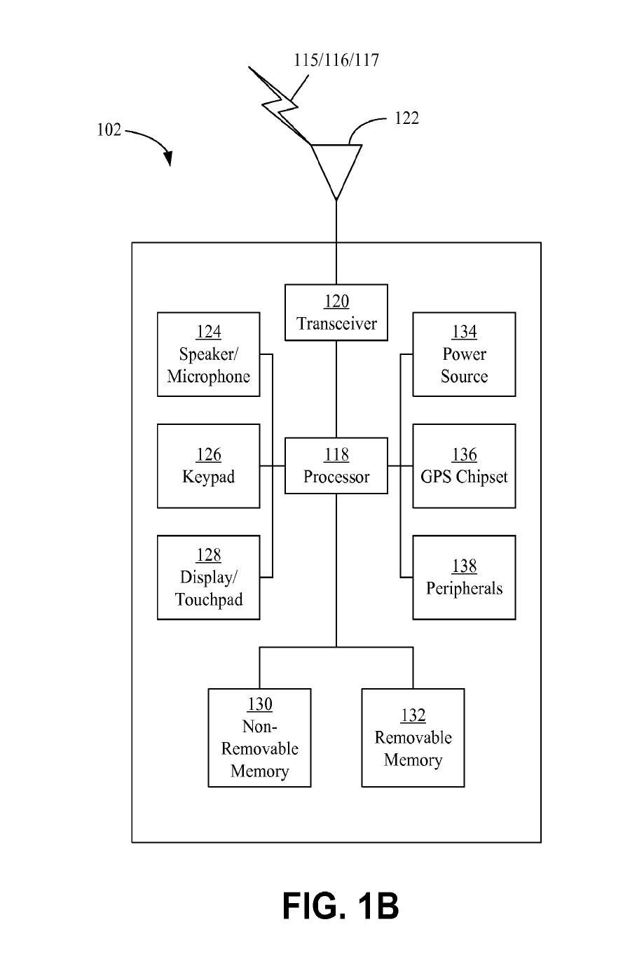

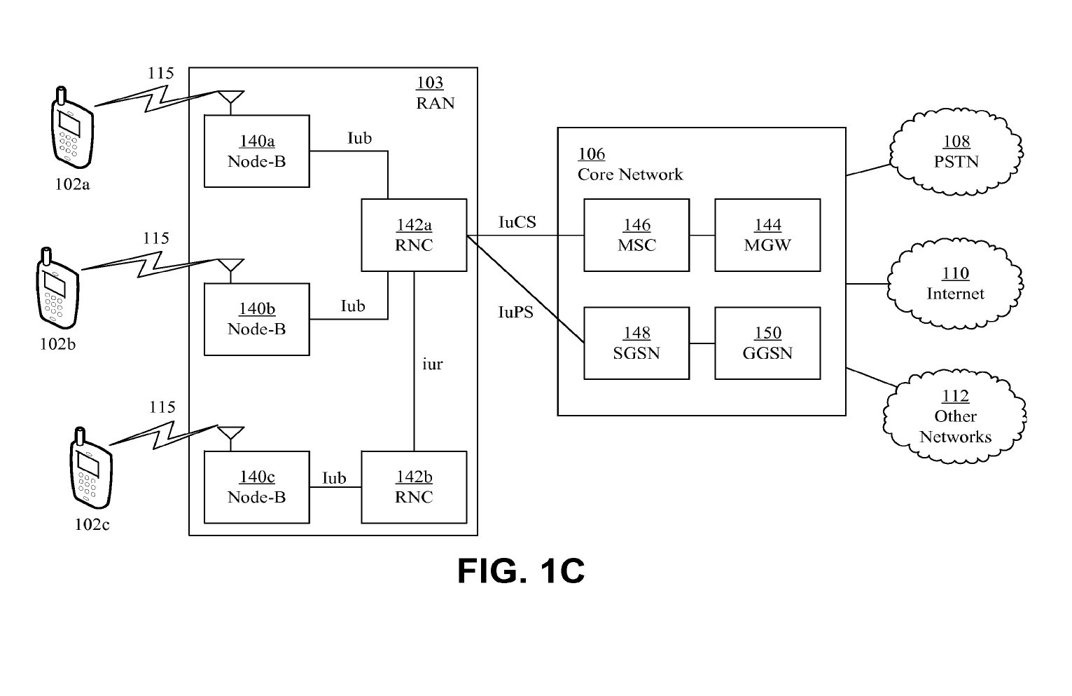

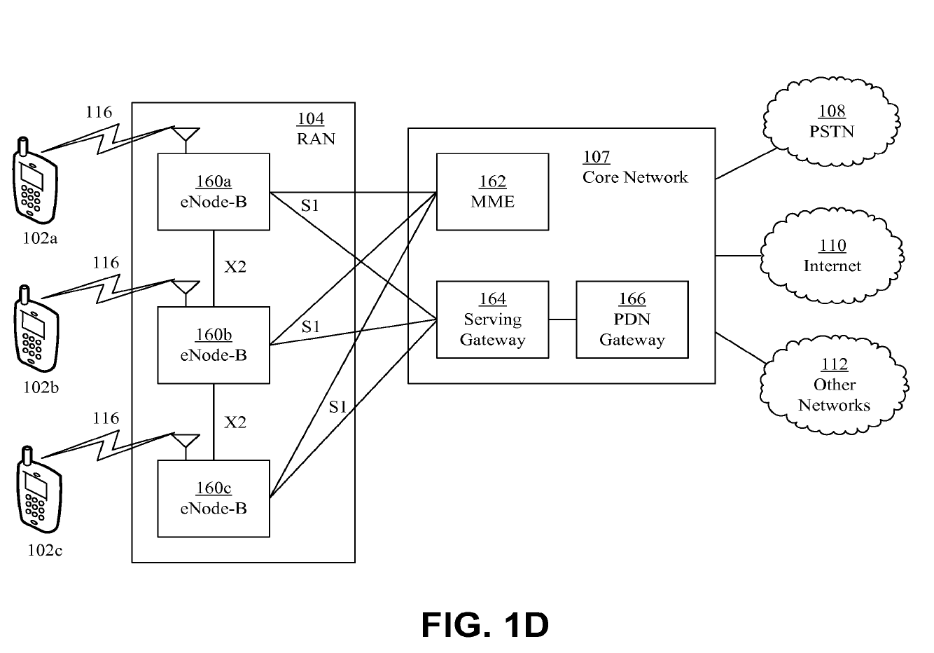

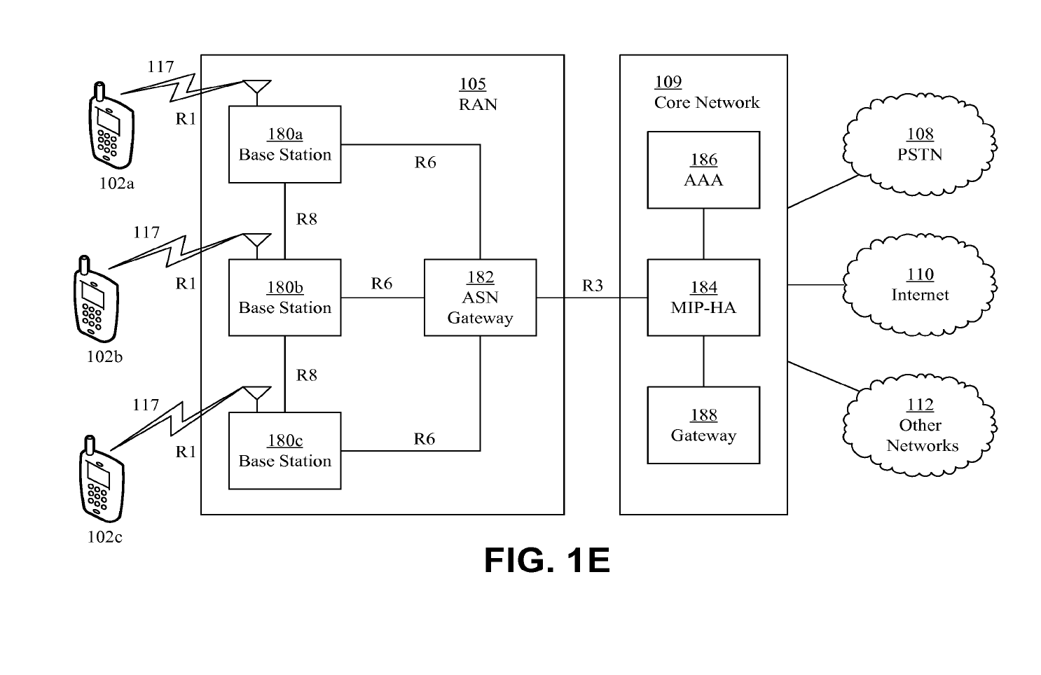

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications system 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, and/or 102d (which generally or collectively may be referred to as WTRU 102), a radio access network (RAN) 103/104/105, a core network 106/107/109, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications system 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106/107/109, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 103/104/105, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, e.g., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 115/116/117, which may be any suitable wireless communication link (e.g., radio frequency (RF), microwave, infrared (IR), ultraviolet (UV), visible light, etc.). The air interface 115/116/117 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 103/104/105 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 115/116/117 using Long Term Evolution (LTE) and/or LTE-Advanced (LTE-A).

In other embodiments, the base station 114a and the WTRUs 102a, 102b, 102c may implement radio technologies such as IEEE 802.16 (e.g., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106/107/109.

The RAN 103/104/105 may be in communication with the core network 106/107/109, which may be any type of network configured to provide voice, data, applications, and/or voice over internet protocol (VoIP) services to one or more of the WTRUs 102a, 102b, 102c, 102d. For example, the core network 106/107/109 may provide call control, billing services, mobile location-based services, pre-paid calling, Internet connectivity, video distribution, etc., and/or perform high-level security functions, such as user authentication. Although not shown in FIG. 1A, it will be appreciated that the RAN 103/104/105 and/or the core network 106/107/109 may be in direct or indirect communication with other RANs that employ the same RAT as the RAN 103/104/105 or a different RAT. For example, in addition to being connected to the RAN 103/104/105, which may be utilizing an E-UTRA radio technology, the core network 106/107/109 may also be in communication with another RAN (not shown) employing a GSM radio technology.

The core network 106/107/109 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 103/104/105 or a different RAT.

Some or all of the WTRUs 102a, 102b, 102c, 102d in the communications system 100 may include multi-mode capabilities, e.g., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment. Also, embodiments contemplate that the base stations 114a and 114b, and/or the nodes that base stations 114a and 114b may represent, such as but not limited to transceiver station (BTS), a Node-B, a site controller, an access point (AP), a home node-B, an evolved home node-B (eNodeB), a home evolved node-B (HeNB or HeNodeB), a home evolved node-B gateway, and proxy nodes, among others, may include some or all of the elements depicted in FIG. 1B and described herein.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 115/116/117. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station (e.g., base stations 114a, 114b) and/or determine its location based on the timing of the signals being received from two or more nearby base stations. It will be appreciated that the WTRU 102 may acquire location information by way of any suitable location-determination implementation while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 103 and the core network 106 according to an embodiment. As noted above, the RAN 103 may employ a UTRA radio technology to communicate with the WTRUs 102a, 102b, 102c over the air interface 115. The RAN 103 may also be in communication with the core network 106. As shown in FIG. 1C, the RAN 103 may include Node-Bs 140a, 140b, 140c, which may each include one or more transceivers for communicating with the WTRUs 102a, 102b, 102c over the air interface 115. The Node-Bs 140a, 140b, 140c may each be associated with a particular cell (not shown) within the RAN 103. The RAN 103 may also include RNCs 142a, 142b. It will be appreciated that the RAN 103 may include any number of Node-Bs and RNCs while remaining consistent with an embodiment.

As shown in FIG. 1C, the Node-Bs 140a, 140b may be in communication with the RNC 142a. Additionally, the Node-B 140c may be in communication with the RNC 142b. The Node-Bs 140a, 140b, 140c may communicate with the respective RNCs 142a, 142b via an Iub interface. The RNCs 142a, 142b may be in communication with one another via an Iur interface. Each of the RNCs 142a, 142b may be configured to control the respective Node-Bs 140a, 140b, 140c to which it is connected. In addition, each of the RNCs 142a, 142b may be configured to carry out or support other functionality, such as outer loop power control, load control, admission control, packet scheduling, handover control, macrodiversity, security functions, data encryption, and the like.

The core network 106 shown in FIG. 1C may include a media gateway (MGW) 144, a mobile switching center (MSC) 146, a serving GPRS support node (SGSN) 148, and/or a gateway GPRS support node (GGSN) 150. While each of the foregoing elements are depicted as part of the core network 106, it will be appreciated that any one of these elements may be owned and/or operated by an entity other than the core network operator.

The RNC 142a in the RAN 103 may be connected to the MSC 146 in the core network 106 via an IuCS interface. The MSC 146 may be connected to the MGW 144. The MSC 146 and the MGW 144 may provide the WTRUs 102a, 102b, 102c with access to circuit-switched networks, such as the PSTN 108, to facilitate communications between the WTRUs 102a, 102b, 102c and traditional land-line communications devices.

The RNC 142a in the RAN 103 may also be connected to the SGSN 148 in the core network 106 via an IuPS interface. The SGSN 148 may be connected to the GGSN 150. The SGSN 148 and the GGSN 150 may provide the WTRUs 102a, 102b, 102c with access to packet-switched networks, such as the Internet 110, to facilitate communications between and the WTRUs 102a, 102b, 102c and IP-enabled devices.

As noted above, the core network 106 may also be connected to the networks 112, which may include other wired or wireless networks that are owned and/or operated by other service providers.

FIG. 1D is a system diagram of the RAN 104 and the core network 107 according to an embodiment. As noted above, the RAN 104 may employ an E-UTRA radio technology to communicate with the WTRUs 102a, 102b, 102c over the air interface 116. The RAN 104 may also be in communication with the core network 107.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, 160c may be associated with a particular cell (not shown) and may be configured to handle radio resource management decisions, handover decisions, scheduling of users in the uplink and/or downlink, and the like. As shown in FIG. 1D, the eNode-Bs 160a, 160b, 160c may communicate with one another over an X2 interface.

The core network 107 shown in FIG. 1D may include a mobility management gateway (MME) 162, a serving gateway 164, and a packet data network (PDN) gateway 166. While each of the foregoing elements are depicted as part of the core network 107, it will be appreciated that any one of these elements may be owned and/or operated by an entity other than the core network operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may also provide a control plane function for switching between the RAN 104 and other RANs (not shown) that employ other radio technologies, such as GSM or WCDMA.

The serving gateway 164 may be connected to each of the eNode-Bs 160a, 160b, 160c in the RAN 104 via the S1 interface. The serving gateway 164 may generally route and forward user data packets to/from the WTRUs 102a, 102b, 102c. The serving gateway 164 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 164 may also be connected to the PDN gateway 166, which may provide the WTRUs 102a, 102b, 102c with access to packet-switched networks, such as the Internet 110, to facilitate communications between the WTRUs 102a, 102b, 102c and IP-enabled devices.

The core network 107 may facilitate communications with other networks. For example, the core network 107 may provide the WTRUs 102a, 102b, 102c with access to circuit-switched networks, such as the PSTN 108, to facilitate communications between the WTRUs 102a, 102b, 102c and traditional land-line communications devices. For example, the core network 107 may include, or may communicate with, an IP gateway (e.g., an IP multimedia subsystem (IMS) server) that serves as an interface between the core network 107 and the PSTN 108. In addition, the core network 107 may provide the WTRUs 102a, 102b, 102c with access to the networks 112, which may include other wired or wireless networks that are owned and/or operated by other service providers.

FIG. 1E is a system diagram of the RAN 105 and the core network 109 according to an embodiment. The RAN 105 may be an access service network (ASN) that employs IEEE 802.16 radio technology to communicate with the WTRUs 102a, 102b, 102c over the air interface 117. As will be further discussed below, the communication links between the different functional entities of the WTRUs 102a, 102b, 102c, the RAN 105, and the core network 109 may be defined as reference points.

As shown in FIG. 1E, the RAN 105 may include base stations 180a, 180b, 180c, and an ASN gateway 182, though it will be appreciated that the RAN 105 may include any number of base stations and ASN gateways while remaining consistent with an embodiment. The base stations 180a, 180b, 180c may each be associated with a particular cell (not shown) in the RAN 105 and may each include one or more transceivers for communicating with the WTRUs 102a, 102b, 102c over the air interface 117. In one embodiment, the base stations 180a, 180b, 180c may implement MIMO technology. Thus, the base station 180a, for example, may use multiple antennas to transmit wireless signals to, and receive wireless signals from, the WTRU 102a. The base stations 180a, 180b, 180c may also provide mobility management functions, such as handoff triggering, tunnel establishment, radio resource management, traffic classification, quality of service (QoS) policy enforcement, and the like. The ASN gateway 182 may serve as a traffic aggregation point and may be responsible for paging, caching of subscriber profiles, routing to the core network 109, and the like.

The air interface 117 between the WTRUs 102a, 102b, 102c and the RAN 105 may be defined as an R1 reference point that implements the IEEE 802.16 specification. In addition, each of the WTRUs 102a, 102b, 102c may establish a logical interface (not shown) with the core network 109. The logical interface between the WTRUs 102a, 102b, 102c and the core network 109 may be defined as an R2 reference point, which may be used for authentication, authorization, IP host configuration management, and/or mobility management.

The communication link between each of the base stations 180a, 180b, 180c may be defined as an R8 reference point that includes protocols for facilitating WTRU handovers and the transfer of data between base stations. The communication link between the base stations 180a, 180b, 180c and the ASN gateway 182 may be defined as an R6 reference point. The R6 reference point may include protocols for facilitating mobility management based on mobility events associated with each of the WTRUs 102a, 102b, 102c.

As shown in FIG. 1E, the RAN 105 may be connected to the core network 109. The communication link between the RAN 105 and the core network 109 may defined as an R3 reference point that includes protocols for facilitating data transfer and mobility management capabilities, for example. The core network 109 may include a mobile IP home agent (MIP-HA) 184, an authentication, authorization, accounting (AAA) server 186, and a gateway 188. While each of the foregoing elements are depicted as part of the core network 109, it will be appreciated that any one of these elements may be owned and/or operated by an entity other than the core network operator.

The MIP-HA may be responsible for IP address management, and may enable the WTRUs 102a, 102b, 102c to roam between different ASNs and/or different core networks. The MIP-HA 184 may provide the WTRUs 102a, 102b, 102c with access to packet-switched networks, such as the Internet 110, to facilitate communications between the WTRUs 102a, 102b, 102c and IP-enabled devices. The AAA server 186 may be responsible for user authentication and for supporting user services. The gateway 188 may facilitate interworking with other networks. For example, the gateway 188 may provide the WTRUs 102a, 102b, 102c with access to circuit-switched networks, such as the PSTN 108, to facilitate communications between the WTRUs 102a, 102b, 102c and traditional land-line communications devices. In addition, the gateway 188 may provide the WTRUs 102a, 102b, 102c with access to the networks 112, which may include other wired or wireless networks that are owned and/or operated by other service providers.

Although not shown in FIG. 1E, it will be appreciated that the RAN 105 may be connected to other ASNs and the core network 109 may be connected to other core networks. The communication link between the RAN 105 the other ASNs may be defined as an R4 reference point, which may include protocols for coordinating the mobility of the WTRUs 102a, 102b, 102c between the RAN 105 and the other ASNs. The communication link between the core network 109 and the other core networks may be defined as an R5 reference, which may include protocols for facilitating interworking between home core networks and visited core networks.

Sensing measurement gaps, e.g., fractional frequency gaps, may be configured. Configuration may be based on, for example, sequentially scheduling sub-bands in a spectral domain as silent periods over an active channel. Different sub-bands may be scheduled to be silent at different times. A sub-band may be silent once over a fixed duration of time.

A sub-band may comprise multiple subcarriers (e.g., PRBs) in a portion of a license-exempt (LE) spectral band. An FFG may be a sensing measurement gap scheduled over at least one sub-band.

In a network, such as a long term evolution (LTE) network, a WTRU may report inter-radio access technology (RAT) and/or inter-frequency measurement information as per the measurement configuration provided by an eNodeB (eNB). The eNB may provide the measurement configuration applicable for a WTRU by, for example, using an RRCConnectionReconfiguration message. An information element (IE) included in a measurement configuration message may be the measurement gap or gaps. The measurement gap or gaps may be the time periods that a WTRU may use to perform inter-RAT and/or inter-frequency measurements. No transmissions may be scheduled for the WTRU in the measurement gap intervals.

In a measurement gap schedule based on a temporal silent period mechanism, an eNB may schedule a time period for measurement and sensing of a WTRU. Control information may be stored in the RRCConnectionReconfiguration message. The measurement gap may be scheduled, for example, in a synchronous fashion over a frequency band. Based on the measurement gap schedule, the WTRUs in a cell may be silent together and may perform the measurements on the frequency band during the scheduled time period. The measurement process may be repeated, e.g., periodically.

A temporal measurement gap may be simple to implement. It may be easy to schedule gaps and make measurements. However, the temporal measurement gap methodology may impact the channel usage efficiency. The WTRUs in a cell may remain quiet for measurement and/or sensing during the gap regardless of the quality of the channels, potentially resulting in inefficient utilization of the wireless spectrum. The WTRUs may be silent during a temporal measurement gap in subframes with good channel quality, but may use subframes with worse channel quality for transmitting data. Such an arrangement may lead to performance reduction and poor channel usage efficiency. The measurement gaps with a certain duty cycle may expect a primary user (PU) to be present all the time, which may not be the case. A PU's usage of the channel may be sporadic and/or infrequent, which may make the use of periodic temporal measurement gaps inefficient.

Periodic and/or aperiodic temporal measurement gaps may be seen as an opportunity to access a channel by other secondary users (SUs), for example, WiFi systems. Frequent temporal measurement gaps may disrupt operation on a license exempt (LE) channel. Complex mechanisms may be used to handle temporal measurement gaps, e.g., to handle discontinuities in the LE band transmission.

Fractional frequency gaps (FFGs) may involve sensing across sub-bands using the fractional frequency gaps. The sensing gaps may be scheduled in two dimensions, e.g., time and frequency. In the case of an OFDM system like LTE, sub-bands in multiples of primary resource blocks (PRBs), e.g., excluding control symbols, may be shut down for sensing during subframes. Such a system may not relinquish a channel to another secondary user system during sensing. FFG may be used in television white space (TVWS) channels for sensing a pilot tone on an Advanced Television Standards Committee (ATSC) signal and wireless microphone detection, both of which may occur on a sub-band. FFG may be used on a shared channel, for sensing a PU such as a radar.

FFG may be used in any OFDM or multicarrier system. FFG may be scheduled on data symbols, e.g., while excluding the control symbols. FFG may use an enhanced physical downlink control channel (ePDCCH) such that the ePDCCH may be moved into the data plane and may be fractionalized.

FFG scheduling may use a deterministic approach, an opportunistic approach, and/or a hybrid approach. A deterministic approach may be centralized and/or eNB-driven. The FFG may be scheduled, for example, by silencing fragments of the LE spectral band sequentially with a predetermined pattern. The eNB may schedule the sub-band gaps for the WTRUs in a cell in a synchronized fashion.

An opportunistic approach may be distributed and/or WTRU-driven. Sensing measurement gaps may be scheduled by silencing fragments of the LE spectral band, for example, based on low instantaneous sub-band channel quality. The sensing gaps may exploit multi-user diversity. Multi-user diversity may be inherent in a wireless network and may be provided by the independent time-varying channels across different users. The sensing measurement gaps may exploit a doubly dispersive nature of channels, e.g., frequency- and/or time-sensitivity of the channel at a WTRU. Sub-band sensing may be scheduled over channel coherence blocks at a WTRU.

In a hybrid approach, an eNB may decide during a time period whether the WTRUs in a cell may use a deterministic scheme or an opportunistic scheme. For example, if a WTRU's feedback measurements are either below a predefined threshold or above a predefined threshold, the eNB may operate in an opportunistic mode. If at least one WTRU detects a certain level of measurement between the two thresholds, the eNB may switch to a deterministic mode.

In an FFG approach, the silent sub-band or sub-bands may be scheduled adjacent to an active sub-band or sub-bands. Such an arrangement may cause leakage of spectrum from an active sub-band into a silent sub-band. Leakage may interfere with the sensitivity used for PU detection in the silent sub-band or sub-bands. Various approaches may be used to mitigate the problem. For example, spectral power may be ramped up in an active sub-band or sub-bands. The transmit power in an active sub-band or sub-bands may be assigned such that the subcarriers near the silent sub-band or sub-bands may have lower power than the subcarriers away from the silent clusters. Spectral shaping may be used for an active sub-band or sub-bands. A predefined spectral shaping filter may be used across the active sub-band or sub-bands so that spectral leakage from the active sub-band or sub-bands into FFG may be reduced or minimized Filters may be defined. The eNB may signal to a WTRU the type of filter that may be used. The selection of the filter may be based on, for example, spectral gap width.

Various FFG signaling schemes may be used. For example, an on broadcast basis scheme may be suitable for a deterministic mode. The eNB may configure and control setup and/or release of measurements for the WTRUs in a cell. A per WTRU basis scheme may be suitable for an opportunistic mode or a hybrid mode. The eNB may configure and control setup and/or release of measurement gaps for the WTRUs in a cell.

FFG schemes may be implemented at the receiver. For example, in frequency division duplex (FDD) downlink spectrum, FFG and sensing may be performed at the WTRU. In FDD uplink spectrum, FFG and sensing may be performed at the eNB. In time division duplex (TDD) downlink subframes, FFG and sensing may be performed at the WTRU. In TDD uplink subframes, FFG and sensing may be performed at the eNB.

An LTE-A network may be operated with an anchor carrier on a licensed spectrum. A supplementary carrier may operate on an LE channel, e.g., TVWS. The downlink may operate on a supplementary band. The WTRUs may perform sensing during downlink subframes. To avoid self-jamming, the eNB may perform sensing. If a full LE channel is to be sensed within a predefined duration (e.g., T₀), silent sub-bands may be scheduled sequentially over different parts of the band, such that the full LE channel may be scanned in every T₀ interval of time.

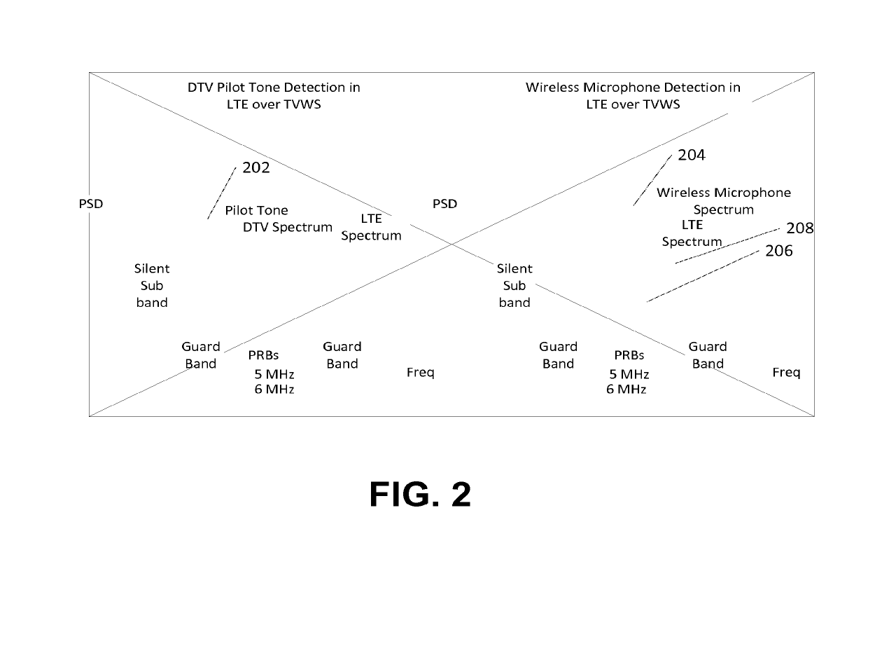

Fractional frequency gaps (FFGs) may involve sensing across sub-bands. A sensing gap may be scheduled in two dimensions, e.g., time and frequency, rather than one dimension, e.g., time. In the case of an OFDM system like LTE, sub-bands in multiples of primary resource blocks (PRBs), e.g., excluding control symbols, may be shut down for sensing during subframes. Such a system may not relinquish a channel to another secondary user system during sensing. FFG may be used in television white space (TVWS) channels for sensing a pilot tone on an Advanced Television Standards Committee (ATSC) signal and wireless microphone detection, both of which may occur on a sub-band of the LTE spectrum, as illustrated by example in FIG. 2. FIG. 2 illustrates an example of sensing a pilot tone 202 on an ATSC signal over TVWS and an example of detecting a wireless microphone spectrum 204 on a silent sub-band 206 of an LTE spectrum 208.

Temporal measurement gaps may not take into account the instantaneous sub-band channel quality when scheduling a measurement gap. The sensing measurement gaps may be scheduled more effectively if the silencing fragments of the LE spectral band are based on low instantaneous sub-band channel quality. Network performance may be improved by scheduling data transmissions on sub-bands with high instantaneous sub-band channel quality, while using sub-bands with low channel quality for sensing.

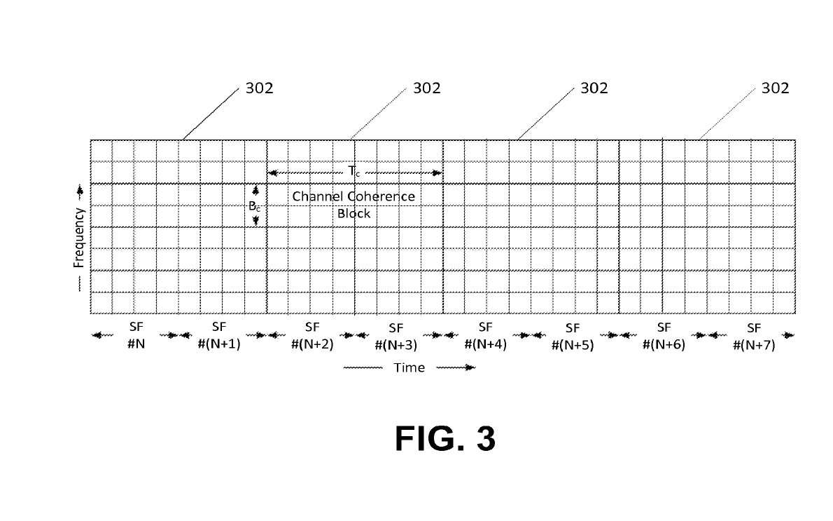

FFG-based sensing and measurement may exploit the doubly dispersive nature of a channel, e.g., frequency- and/or time-selectivity of the channel at a WTRU. As illustrated by example in FIG. 3, FFGs may be scheduled over channel coherence blocks 302 at a WTRU based on feedback. For example, T_{c} may be the coherence time, and B_{c} may be the coherence bandwidth. Scheduling the measurement gaps based on channel coherence blocks 302 may provide networks with flexibility on scheduling the gaps on specific bands that may be sensed and measured. Based on the instantaneous sub-band channel quality information, smart scheduling schemes may be deployed.

A PRB may span control OFDM symbols (e.g., ePDCCH) and data OFDM symbols, scheduling an FFG as multiples of PRBs. This may be done, for example, by including the control OFDM symbols (e.g., ePDCCH) in the FFG and/or excluding the control OFDM symbols (e.g., ePDCCH) from the FFG. When the control OFDM symbols (e.g., ePDCCH) are excluded from the FFG, there may be no impact on the transmission and reception of control OFDM symbols (e.g., ePDCCH). If the control OFDM symbols (e.g., ePDCCH) are included in the FFG, a portion of the control OFDM symbols (e.g., ePDCCH) may be lost due to the FFG. The lost portion may be reinserted in the data OFDM symbols. For example, the lost subcarriers of the control OFDM symbols may be inserted anywhere in the first few data OFDM symbols after (e.g., immediately after) the control OFDM symbols (e.g., ePDCCH). The control symbols may be mapped onto subcarriers that may not be part of the FFG.

A deterministic approach may involve scheduling sensing measurement gaps by, for example, sequentially silencing fragments of the LE spectral band. An eNB may schedule the sensing measurement gaps for the WTRUs in a cell in a synchronized fashion. A sensing measurement gap pattern may repeat after a set of frames based on, for example, a predetermined duty cycle. A measurement gap, e.g., scheduled as a subset of subcarriers may be a fractional frequency gap (e.g., multiples of PRBs). A width (e.g., in number of subcarriers) of the FFG across subframes may be fixed for the sub-bands or may be variable across sub-bands. The time duration for the FFG may be fixed for the sub-bands or may be variable across sub-bands. The FFG pattern may be fixed for a cell or may be semi-static and/or dynamic.

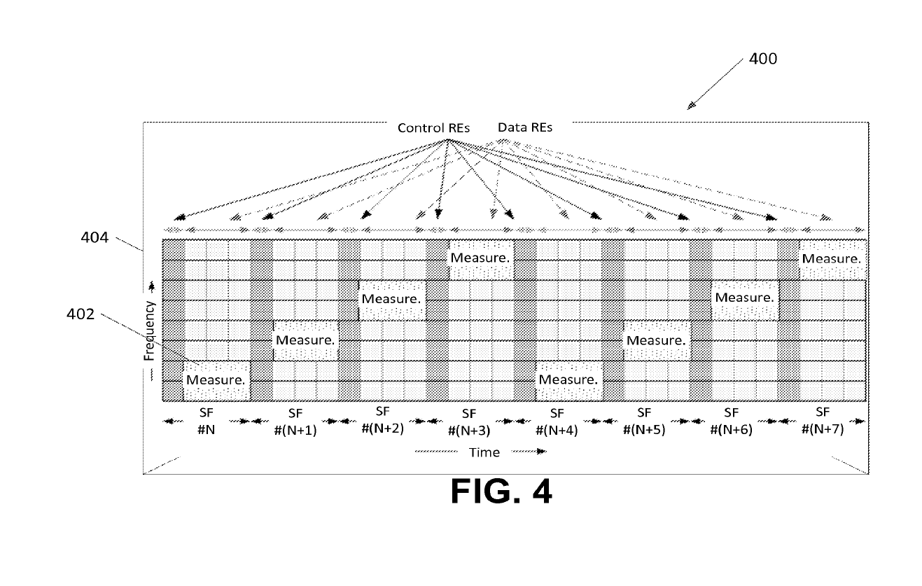

Sensing measurement gaps may be scheduled by scheduled by silencing fragments of the LE spectral band sequentially and sensing on the silenced fragment. FIG. 4 illustrates, by way of example, an LTE frame structure 400 in time and frequency domains from, for example, subframe N to subframe N+7. For example, in subframe N, a measurement gap 402 may span a lower band of subcarriers, while in subframe N+1, a measurement gap 404 may span a higher band of subcarriers. The pattern may repeat after a set of frames based on a predetermined duty cycle. A measurement gap may be scheduled as a subset of subcarriers (e.g., FFG). The width (e.g., in number of subcarriers) of the FFG gap may be the same or different across subframes. The FFGs may sweep the spectral band to assess the spectrum occupancy.

In an FFG scheme of scheduling measurement gaps, a subframe may not be completely lost due to a gap. The FFG length may be chosen such that a narrow band secondary user may be accommodated during the gap. Such an arrangement may allow coexistence of secondary users.

An FFG may be designed in such a way that the FFG length is equal to a number of physical resource blocks assigned to a WTRU. In a subframe, at least one of the WTRUs may have assigned resource blocks, while the others may not.

In an opportunistic approach, the WTRUs may be proactive in a sensing and measurement process. The eNB may not send out a control signaling message or messages to signal the sensing measurement gap pattern. A WTRU, for example, based on channel quality, may independently sense a specific sub-band. For example, if a WTRU opportunistically detects a low quality channel that may be based on a low sub-band CQI measurement on the spell-specific RSs or low sub-band RSSI measured on the sub-band, in one or more of its coherence blocks, the WTRU may automatically sense on those sub-bands or coherence blocks. The WTRU may proceed without waiting for a sensing measurement gap schedule message from the eNB. A WTRU may observe a different fading profile in time and frequency due to the random nature of the multipath and/or varying WTRU speeds. Based on the instantaneous sub-band channel quality, the WTRUs may cooperate proactively with the eNB to schedule the sensing measurement gaps.

The eNB may collect measurement reports sent by WTRUs. These reports may provide the sensing reports corresponding to the resource blocks. The eNB may fuse sensing information from a number of WTRUs. For example, at subframe N−1 of the total N frames of a period, the eNB may determine the sub-bands that have not been reported. The eNB may signal all or some of the WTRUs to perform measurements, sense on those sub-bands, and report the results.

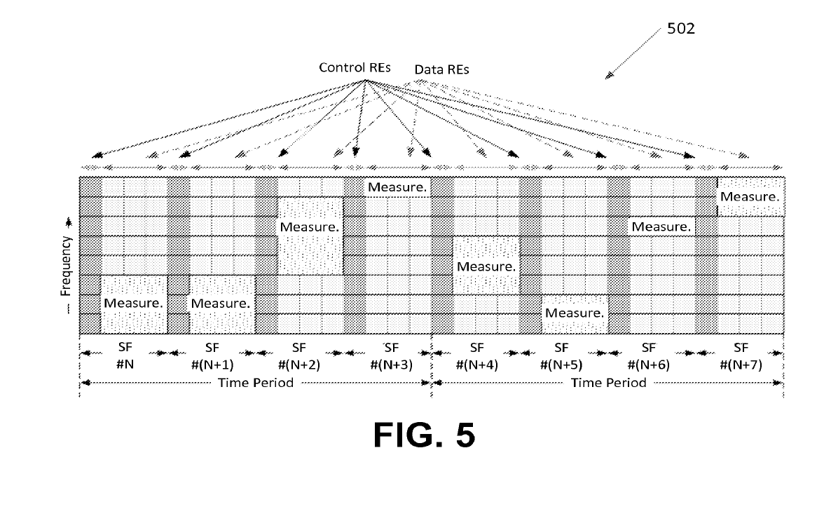

The width (e.g., in number of subcarriers) of the FFG may be variable across sub-bands based on the frequency-selective nature of a channel at the WTRU. The time duration of a FFG may be variable based on the time-selective nature of a channel at the WTRU. FIG. 5 illustrates, by way of example, fractional frequency gap patterns 502 in an opportunistic approach. This scheme may not require the WTRU in a cell to perform the frequency measurement on the whole band.

An opportunistic approach may have advantages over a deterministic approach. An opportunistic approach may be effective when the gap measurement occurs over sub-bands with low quality. When the channel quality of a sub-band is not very bad, e.g., when transmissions from the eNB may be heard at the WTRU on that sub-band, sensing measurements on that sub-band may not be reliable. A hybrid solution between deterministic and opportunistic schemes may be provided.

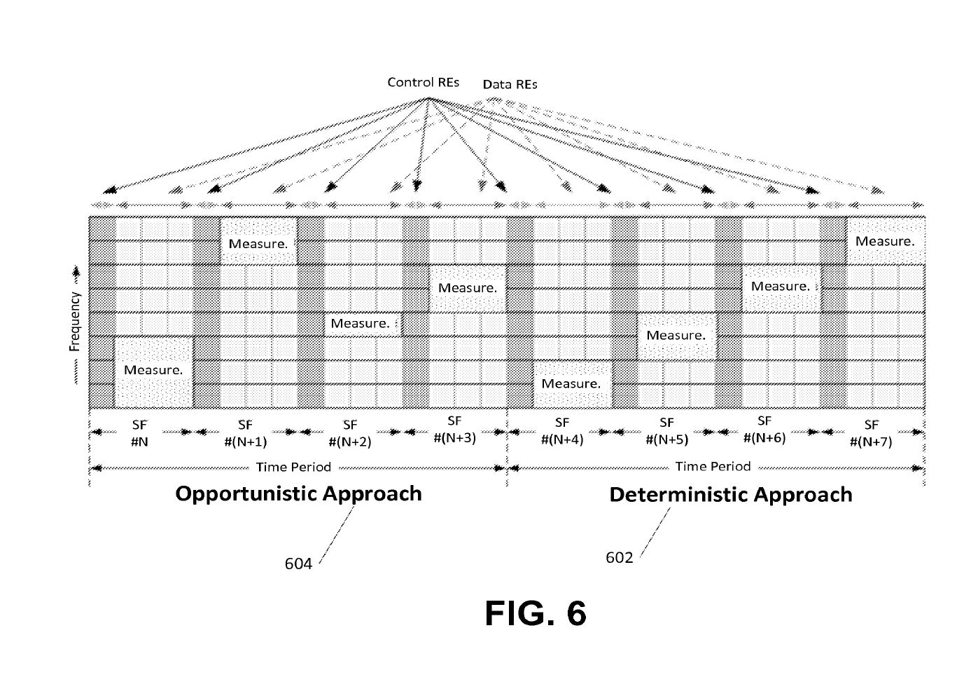

FIG. 6 illustrates example frequency measurements using a hybrid approach. A hybrid approach may adapt as per the status of the network. The hybrid approach may, for example, switch the sensing mode of the network between deterministic and opportunistic approaches. The eNB may decide if a WTRU may perform the sensing measurement gaps using a deterministic approach 602 or an opportunistic approach 604. For example, if a WTRU's feedback measurements are reliable, e.g., either below a threshold Threshold2 or above a threshold Threshold1 corresponding to events S1, S2, the eNB may drive the cell to operate on an opportunistic approach.

The measurement results from the WTRUs may provide accurate information to the eNB about the presence of a primary user (PU) on a sub-band. The opportunistic approach may involve less measurement from the WTRU and may be favorable.

If at least one WTRU detects an unreliable measurement, e.g., a certain level of measurement on operating sub-bands that lie between the two thresholds (e.g., an uncertain zone, defined herewith as an event S3), the eNB may drive the cell to operate on a deterministic approach. The deterministic approach may provide more accurate sensing results since the WTRUs in a cell may perform sensing together on similar sub-bands.

A threshold tₜₕᵣₑₛₕ may trigger the switching of an operating mode, e.g., between a deterministic approach and an opportunistic approach. If the measurement results repeat on at least tₜₕᵣₑₛₕ consecutive periods, the eNB may change from one approach to another to provide a favorable measurement mode for the cell.

In an FFG approach, the silent sub-band or sub-bands may be scheduled adjacent to an active sub-band or sub-bands. Such an arrangement may cause leakage of spectrum from an active sub-band or sub-bands into a silent sub-band or sub-bands. Leakage may interfere with the sensitivity used for PU detection in the silent sub-band or sub-bands. Various approaches may be used to mitigate the interference.

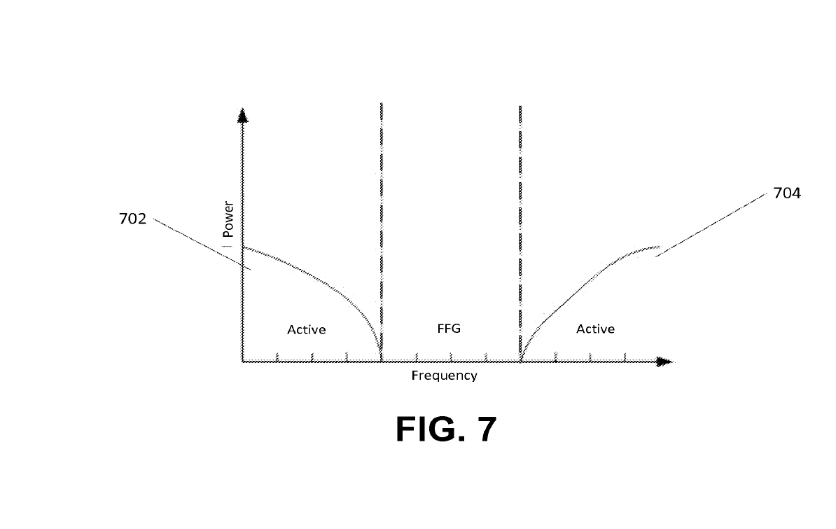

FIG. 7 illustrates by example spectral power ramp up in an active sub-bands approach. Transmit power in active sub-bands 702, 704 may be assigned such that the subcarriers near the silent sub-band may have lower power than the subcarriers away from the silent clusters.

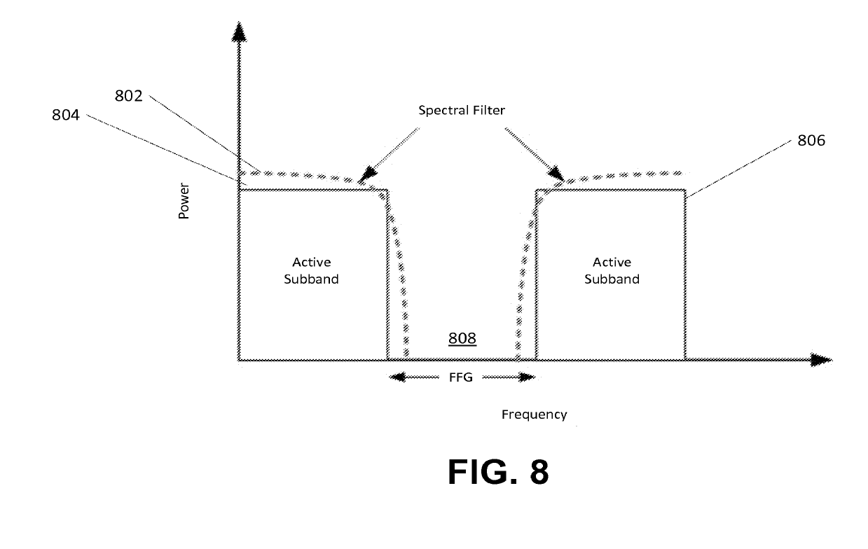

FIG. 8 illustrates by example spectral shaping over an active sub-bands approach. The filtering technique may be adapted to sharpen the spectrum over the active sub-bands. A spectral shaping filter 802 across active sub-bands 804, 806 may be used so that the spectral leakage from active sub-bands into an FFG 808 may be reduced or minimized Filters may be defined such that the eNB may signal to the WTRU the filter to be used. The selection of the filter may be based on, for example, the spectral gap width.

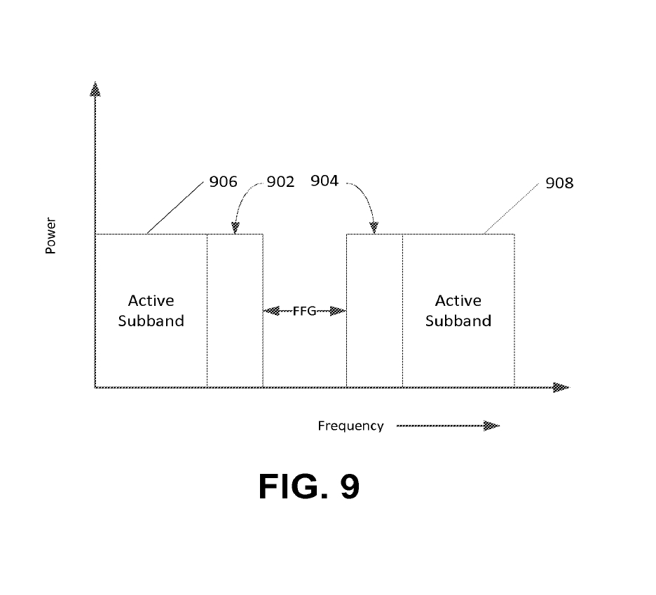

As illustrated in FIG. 9, for example, a predefined guard band or guard bands 902, 904 may be defined between the active sub-band or sub-bands 906, 908 and the silent sub-band or sub-bands so that leakage from the active sub-band or sub-bands into the silent sub-band or sub-bands may be reduced or minimized

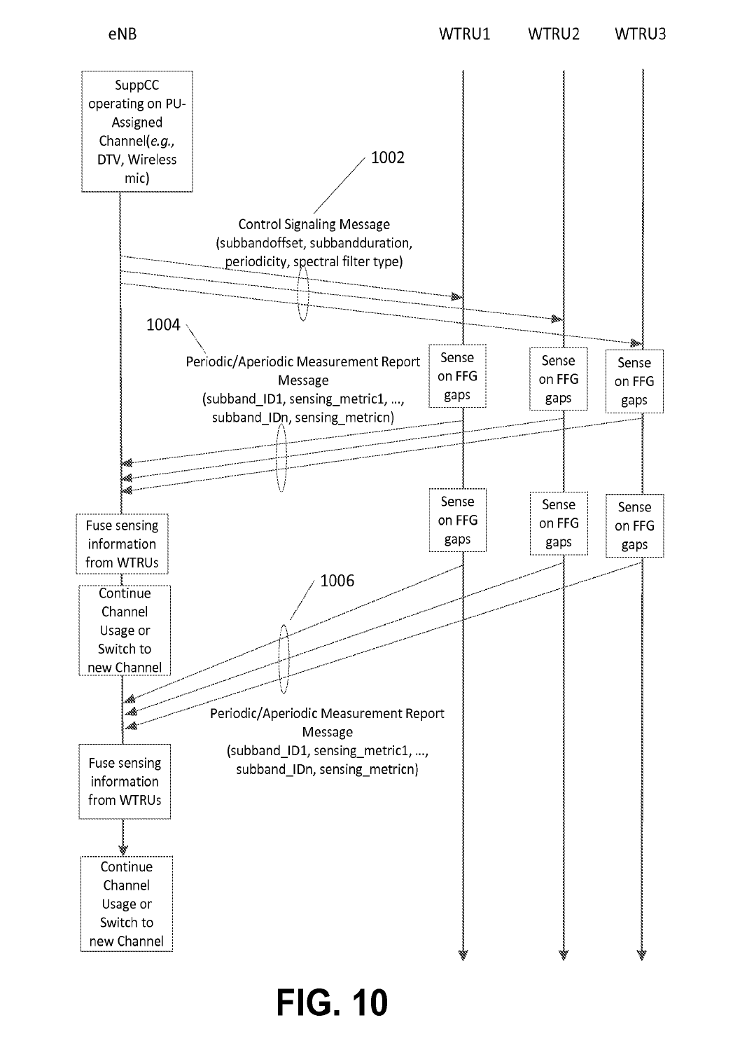

FIG. 10 illustrates example signaling in a deterministic approach. Information including, for example, the FFG type, FFG pattern, and/or filter type may be signaled from the eNB to schedule FFG at the WTRU using, for example, a control signaling message 1002. The FFG type may convey to the WTRU whether the FFG gap pattern may be signaled to the WTRU by the eNB in a deterministic fashion or whether the WTRU may opportunistically sense sub-bands that the WTRU may determine to be weak. A bit may be used. For example, a value of zero may indicate a deterministic approach, while a value of one may indicate an opportunistic approach.

In a deterministic approach, the eNB may signal the gap pattern to indicate the time duration of a sub-band gap (e.g., the number of slots) and/or number of physical resource blocks (PRBs) in a sub-band gap. The eNB may signal the sub-band spectral filter type to be used to suppress leakage from an active sub-band to a silent sub-band.

As illustrated by example in FIG. 10, information including, for example, sub-band ID, sensing metric, and/or event report may be signaled from the WTRU to the eNB as a part of a measurement report message 1004, 1006. A sub-band ID may provide the identity of the sub-band for which a sensing measurement is being reported. A sensing metric may provide a sensing measurement metric value associated with a sub-band ID. Examples of sensing measurement metrics may include, for example, waveform and/or feature detection of a primary incumbent of a spectrum such as the energy in the pilot tone of a digital television (DTV) waveform, the energy in the FM tone of a wireless microphone, a radar, or the like. A sensing measurement metric may include a waveform and/or feature detection of a secondary user coexisting in the spectrum, such as the energy in the preamble of a coexisting WiFi system, the RSSI measured over a sub-band, or the like. The event report may include, for example, an ID of a predefined measurement event that may have occurred, e.g., a particular metric that may exceed or fall below a threshold.

A control signaling process to implement FFGs may be provided. Signaling may be based on the type of gap measurement approach. For example, a deterministic approach may involve less enhancement to the LTE protocol than an opportunistic approach.

In LTE, an information element (IE), for example, a MeasGapConfig IE, may specify the measurement gap configuration and may control setup and/or release of measurement gaps. Such information may be included in the control signaling message that the eNB may send to the WTRUs for the measurement gaps scheduling.

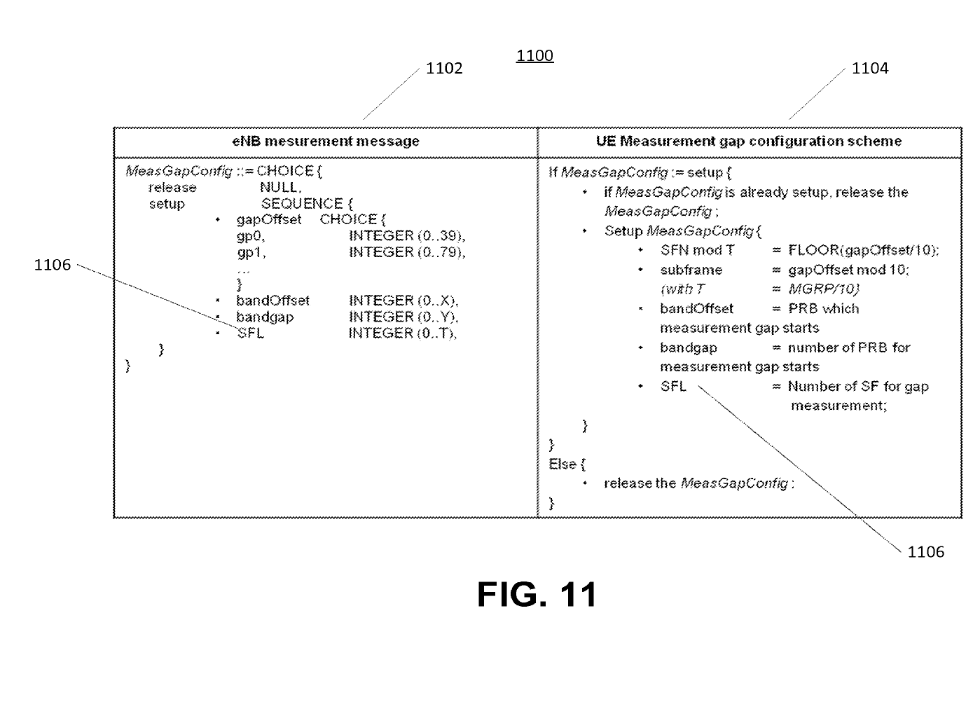

In a deterministic mode, an IE, such as a MeasGapConfig IE, may reflect the fractional frequency gap configuration. FIG. 11 illustrates example measurement signaling parameters in a deterministic approach. FIG. 11 illustrates an example MeasGapConfig IE 1100 that may be used in a deterministic approach. The MeasGapConfig IE 1100 may include an eNB measurement message structure 1102 and/or a response 1104 of the WTRU while processing an RRC message from an eNB. The parameters added to a MeasGapConfig message may include a System Frame Length (SFL) 1106 that may specify a number of frames that may be used for a measurement gap. T sub-frames may provide a length of a repetition period of the measurement gaps (e.g., T=4 with Gap Pattern ID 0, T=8 with Gap Pattern ID 1, etc.).

Parameters X and Y of a MeasGapConfig IE may have different values. For example, a parameter X may indicate a PRB or PRBs at which the measurement gap may start. A maximum value of X may be equal to the number of PRBs on the channel bandwidth. Example values of X may include, for example, 6 (e.g., on a 1.4 MHz bandwidth), 25 (e.g., on a 5 MHz bandwidth), and 100 (e.g., on a 20 MHz bandwidth). A parameter Y may indicate a number of PRBs that may be equivalent to a length of a measurement gap or measurement gaps in the frequency domain.

The parameter X may indicate an ID of PRBs at which the measurement gap may start. The parameter Y may indicate an ID of PRBs at which the measurement gap may end.

A MeasGapConfig IE may include parameters, e.g., X₁, X₂, . . . , Xₙ that may indicate the ID or IDs of PRBs where the measurement gaps may be assigned. In this case, multiple gaps may be scheduled in one sub-band. A larger header size may be used in connection with such a mechanism of scheduling multiple gaps.

If spectral leakage into a silent sub-band is reduced using spectral power ramp-up in active sub-bands, a parameter power_ramp-up_id may be included in a MeasGapConfig message. The parameter power_ramp-up_id may indicate the transmitter (Tx) power allocation pattern that may be used to enable spectral power ramp-up in active sub-bands at silent band boundaries.

If spectral leakage into a silent sub-band is reduced using spectral shaping over active sub-bands, a parameter filler_id may be included in the MeasGapConfig message. The parameter filter_id may define a spectral shaping filter that may be used by WTRUs on active sub-bands, e.g., sub-bands that may be used for data transmission and/or reception.

A WTRU may perform measurement and/or sensing on FFG gaps as in the control message from the eNB. In a deterministic approach, this may be repeated, e.g., periodically.

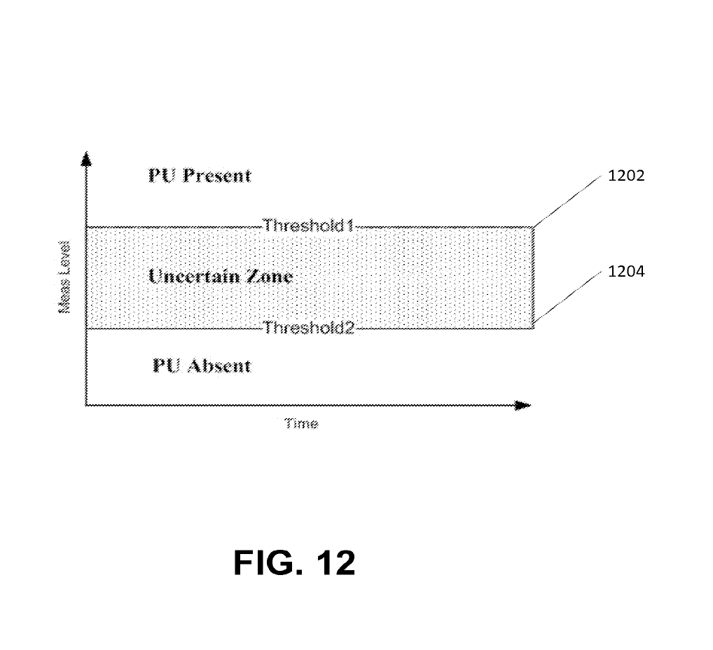

FIG. 12 illustrates example sub-band measurement events at a WTRU. A WTRU may compare a sub-band sensing measurement metric or metrics against a threshold or thresholds 1202, 1204 provided by an eNB. Depending on the outcome of the sub-band sensing measurement comparison or comparisons, the WTRU may define a sub-band measurement event or events. For example, an event S1 may represent a condition when a sub-band measurement metric may be less than or equal to a threshold Threshold2, e.g., where the PU may be absent. An event S2 may represent a condition when the sub-band measurement metric may be greater than or equal to a threshold Threshold1, e.g., when the PU may be present. An event S3, for example, may represent a condition when the sub-band measurement metric may be between the thresholds Threshold1 and Threshold2, e.g., an uncertain zone.

Sensing measurements reported to an eNB may help the eNB make a decision on utilizing sub-bands based on the status of the cell. For example, if the WTRUs in a cell report an event S1 for a specific sub-band or sub-bands (e.g., equivalent to PU absent), the eNB may schedule the sub-bands for data transmissions. If at least one WTRU in a cell reports an event S2 for a specific sub-band or sub-bands (e.g., equivalent to PU present), the eNB may schedule the sub-bands for sensing and measurement gaps.

If no WTRU in the cell reports, for example, event S2 but at least one WTRU reports an event, e.g., event S3 for a specific sub-band or sub-bands (e.g., the uncertain zone), the eNB may signal the WTRU or WTRUs that reported the event S3 to perform frequency measurement. Frequency measurement may be repeated until the WTRUs in the cell may return the events S1 or S2 or the number of times repeating the frequency measurement reaches a threshold, e.g., t_repₘₐₓ. If the final outcome of this frequency measurement is that an event S1 is not reported, the eNB may assume that the PU is present on that sub-band.

The sensing results from the WTRU back to the eNB may be signaled via a MAC control element (CE) to indicate the detection of a PU at a WTRU. Reporting the presence of a PU to the eNB in this way may be faster than the RRC signaling approach.

The WTRU may signal the sensing results using the physical uplink control channel (PUCCH) and/or physical uplink shared channel (PUSCH) channels. Some resource elements on the physical uplink control channel (PUCCH) may be reserved to signal the presence of a primary user. Information about the type of the primary user, measurement metric value, etc., may be signaled using the physical uplink shared channel (PUSCH), for example, by piggybacking the data payload with this information. Certain resource elements and/or blocks may be reserved for this information.

For event-triggered reporting, PHY signaling may be used. For periodic signaling based on a reporting schedule, RRC and/or MAC signaling may be used. The regulator's criteria on detection and reporting latency may help in determining the selection of the signaling type.

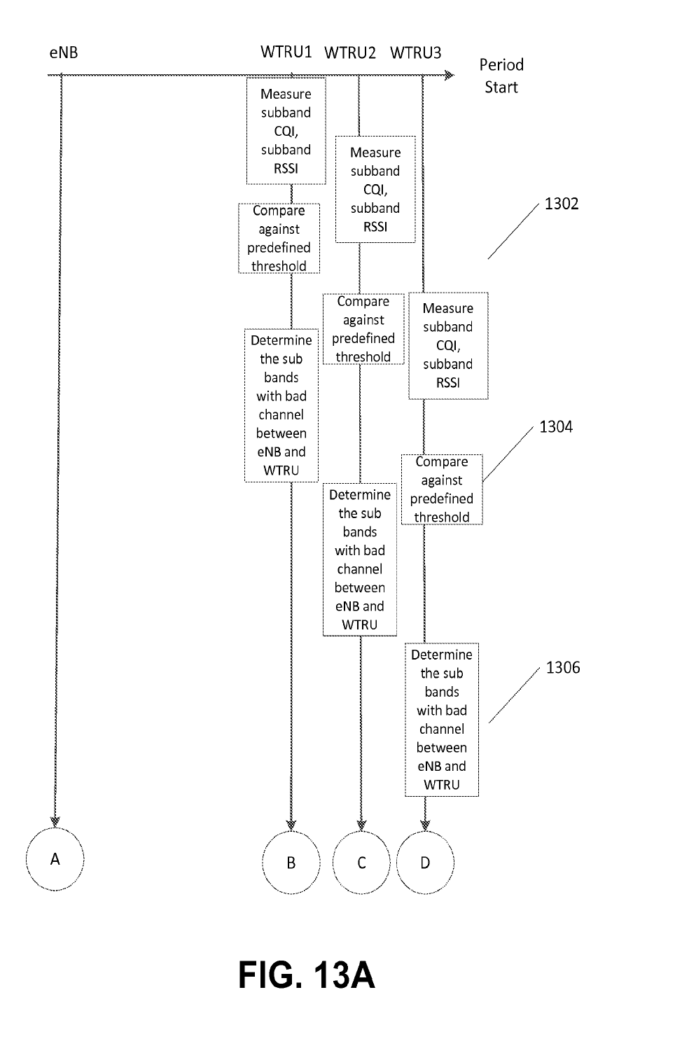

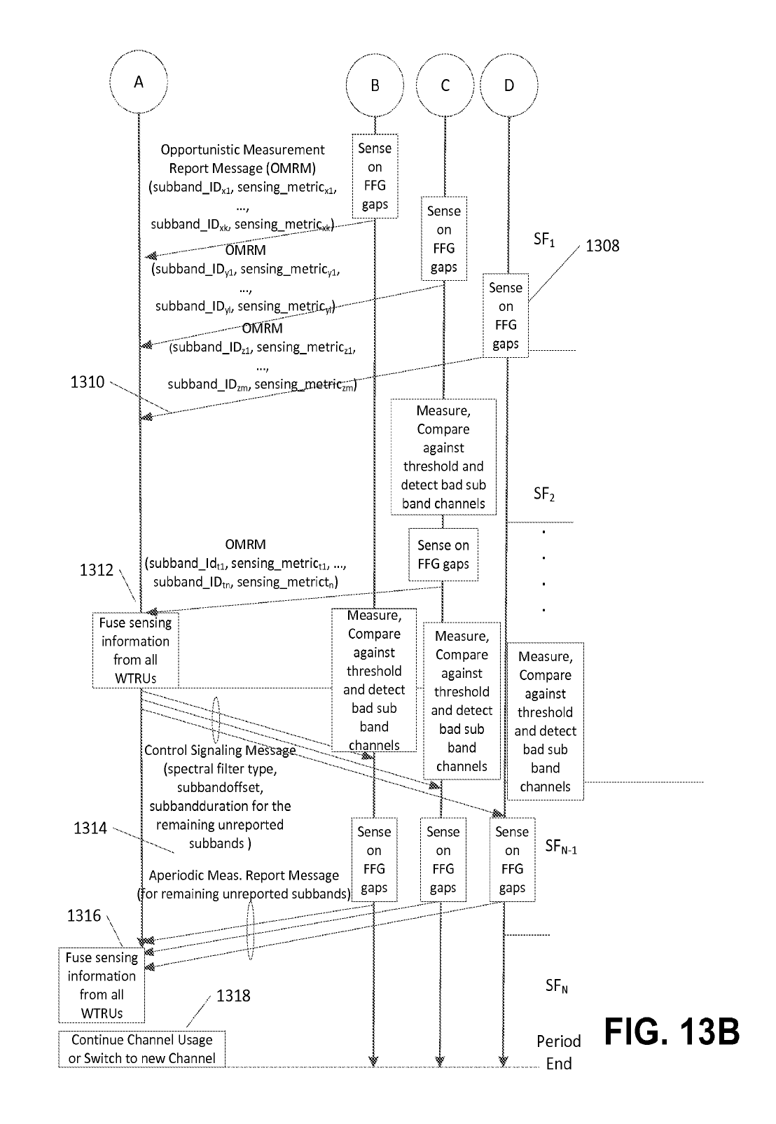

FIGS. 13A-13B illustrate example control signaling in an opportunistic approach. In an opportunistic approach, the WTRU may be more proactive in performing the frequency measurement and sensing. For example, a WTRU may measure a sub-band CQI and/or a sub-band RSSI at 1302, compare the measurement(s) against a threshold at 1304, and determine a sub-band or sub-bands with a bad channel between the eNB and the WTRU at 1306. Sensing may be performed on FFG gaps at 1308. An opportunistic measurement report message (OMRM) 1310 may be sent to the eNB. At 1312, the eNB may combine sensing information from multiple, e.g., all WTRUs. The eNB may receive an aperiodic measurement report message (AMRM) 1314 for one or more remaining unreported sub-bands. This sensing information may be combined at 1316. The eNB may continue channel usage or switch to a new channel at 1318.

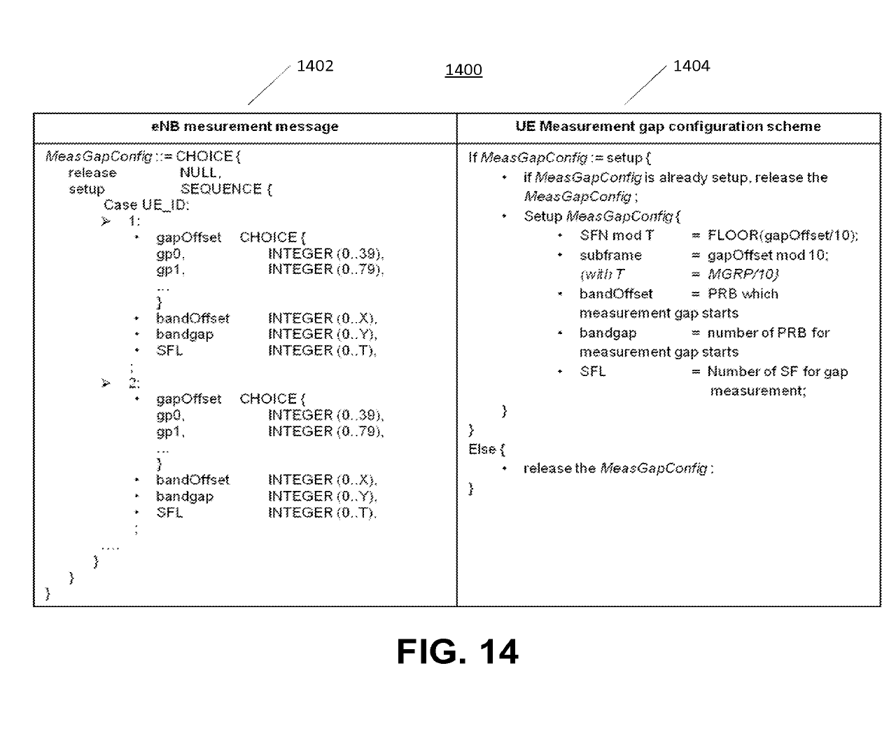

FIG. 14 illustrates an example measurement gap configuration IE 1400 in an opportunistic approach. The information provided by the IE 1400 may be on a per WTRU basis. The measurement gap configuration IE may include an eNB measurement message structure 1402 and/or a response 1404 of the WTRU when processing the RRC message from the eNB. The parameters added to the MeasGapConfig message may be the same as or similar to those used in a deterministic approach and may be repeated for a number of WTRUs.

A hybrid approach may adapt with the status of the network, e.g., by switching between a deterministic approach and an opportunistic approach. Signaling may involve a combination of signaling per a deterministic approach and signaling per an opportunistic approach.

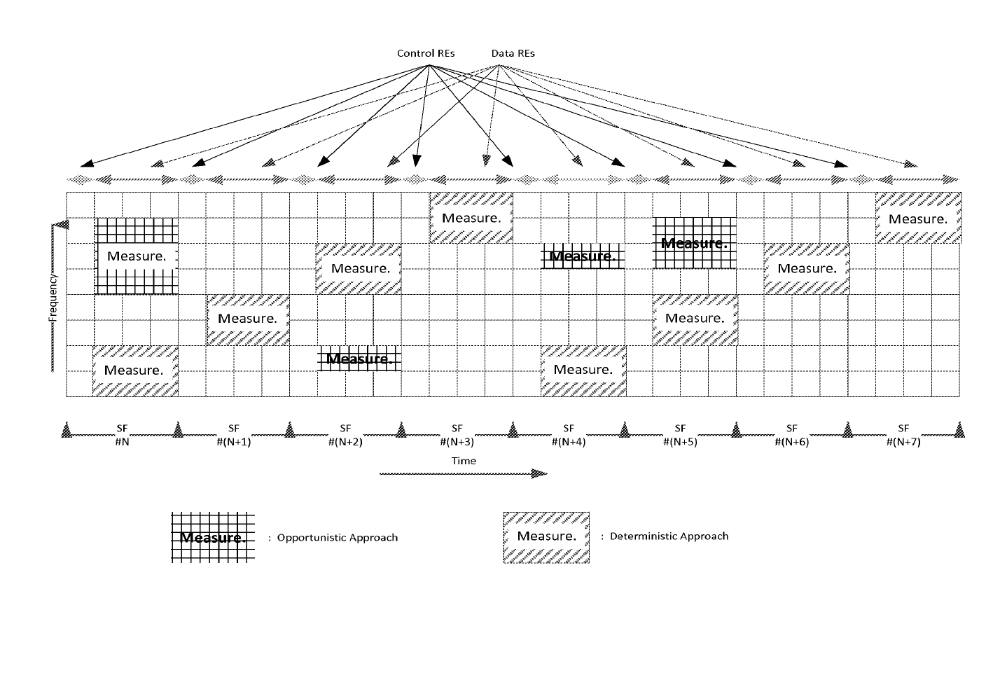

A hybrid approach, an example of which is shown in FIG. 15, may switch between deterministic and opportunistic approaches to work more effectively. A dual approach may combine deterministic and opportunistic approaches. When the eNB may detect that some channel qualities are not good with WTRUs that may provide unreliable sensing measurements, the eNB may drive a cell to operate in a deterministic mode. If other WTRUs may provide reliable sensing measurement information over some channels, the eNB may support them to operate in an opportunistic mode. A hybrid approach may switch between deterministic and opportunistic modes and may maintain a cell in a single mode at a particular time. A dual mode may support dual methods simultaneously. For example, a deterministic mode may be set to some sub-bands and frequency gaps, while an opportunistic mode may be set to other sub-bands and frequency gaps. This may lead to a more optimal solution, for example, in large networks with a high density of WTRUs and a diversity of channel qualities.

When a plurality of WTRUs may detect the presence of a primary user based on a deterministic approach or on an opportunistic approach and may decide to report the event, the uplink of the system may be overloaded with measurement reports by a number of WTRUs, and some reports may not get through. Measurement report overloading may be avoided, for example, by using a random back off for event-triggered events. For example, when a WTRU detects that a predefined event may be triggered based on a sensing measurement metric, the WTRU may back off by a random number of time slots before reporting it to the eNB. By using random back off, the probability of collisions on the uplink created by simultaneous triggering of events at a number of WTRUs may be reduced or minimized.

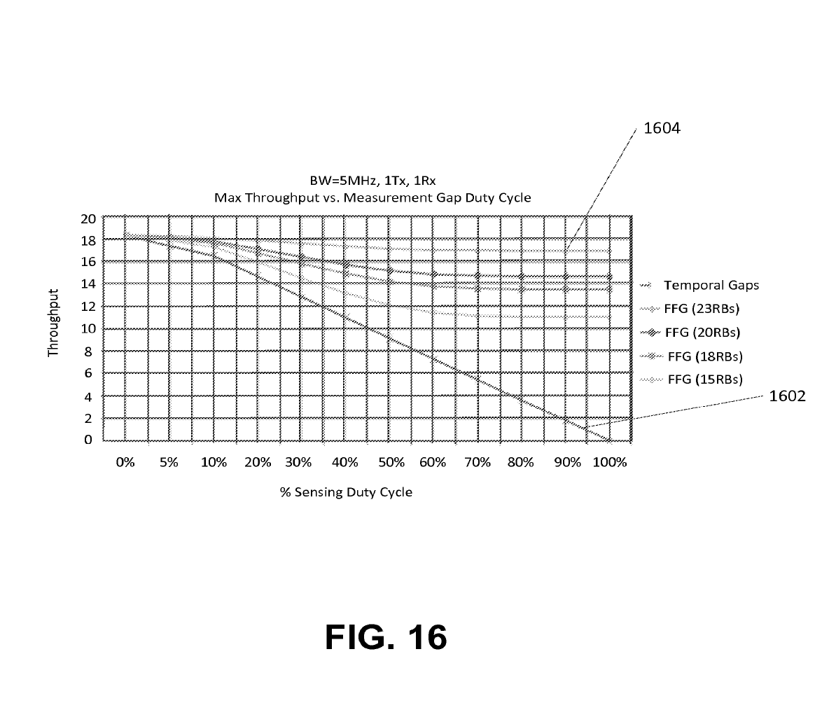

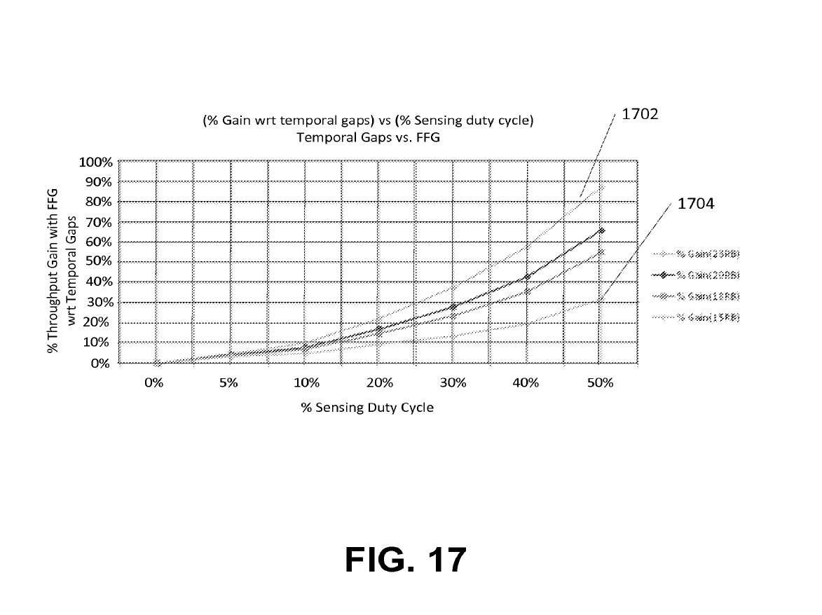

FIG. 16 illustrates an example throughput comparison of a temporal gap approach with an FFG approach. FIG. 17 illustrates an example throughput gain with FFG with respect to temporal gaps for a given sensing duty cycle. FIGS. 16 and 17 illustrate by example a quantitative analysis of throughput gains that fractional frequency gaps may achieve relative to temporal gaps. Gaps may be scheduled in a deterministic fashion, e.g., the gap schedule may be known beforehand, the gap duty cycle may be fixed, and/or the gaps may occur at predefined times.

In one scenario, for example, the LE channel under consideration may have a bandwidth of 5 MHz (e.g., as in LTE operation over a TVWS channel). The wireless link condition may be additive white Gaussian noise (AWGN) with high signal-to-noise ratio (SNR), e.g., a near-ideal channel that may allow maximum possible transport format for a 5 MHz channel. In such a scenario, a throughput drop may be expected as shown, e.g., in FIGS. 16 and 17. The throughput drop maybe based on the gaps in transmission that may be scheduled to enable robust sensing of primary and/or secondary users using the same spectrum by avoiding self-interference.

In FIGS. 16 and 17, the notation FFG (e.g., N RBs) may imply that N PRBs out of, for example, 25 PRBs in the case of a 5 MHz channel may be allocated to a physical downlink shared channel (PDSCH). The remaining PRBs may be left empty and/or unassigned so that they may be used for sensing in the sub-band spanned by those PRBs. A sensing duty cycle may indicate a percentage of subframes allocated for silent periods and/or gaps per frame. For example, in the case of the temporal gaps, a 50% sensing duty cycle may imply five complete subframes out of every ten subframes that may be allocated for sensing. In the case of the FFG of, for example, a 50% sensing duty cycle may imply that in five subframes out of every ten subframes in a frame, sub-band gaps may be scheduled for sensing (e.g., in a sub-band location in the 5 MHz channel).

A temporal gap curve 1602 in FIG. 16, for example, may depict an increasing loss in throughput using a temporal gap approach as a function of increasing sensing duty cycle. For example, an 80% sensing duty cycle may provide a lower net throughput than a 20% sensing duty cycle. An FFG (23 RBs) curve 1604 may correspond to a fractional frequency gap approach in which, for example, 23 PRBs may be active and allocated to the WTRUs, while the remaining PRBs may be empty and used for sensing in the sub-band. Appropriate spectral filtering of active PRBs may be possible to reduce or minimize and/or eliminate spectral leakage from the active sub-band to the silent and/or empty sub-band to avoid self-interference when sensing on the empty sub-band.

FIG. 17, for example, shows that with the FFG approach, the lower the number of active PRBs in a subframe, the greater may be the loss in throughput. An FFG (23 RBs) curve 1702 may correspond to a fractional frequency gap approach in which, for example, 23 PRBs may be active and allocated to the WTRUs, while the remaining PRBs may be empty and used for sensing in the sub-band. An FFG (15 RBs) curve 1704 may correspond to a fractional frequency gap approach in which, for example, 15 PRBs may be active and allocated to the WTRUs, while the remaining PRBs may be empty and used for sensing in the sub-band. The curves 1702, 1704 may show that with more active PRBs, a higher throughput gain may be realized with an FFG approach relative to a temporal gap approach for a given sensing duty cycle. The FFG approach may provide better throughput performance relative to the temporal gap approach.

In an FFG approach, the complexity of implementing a spectral filter across the active sub-band may be lower when the number of empty PRBs may be higher, e.g., when the number of active PRBs may be lower. The lower number of active PRBs may, however, impact the throughput.

FIGS. 16 and 17 illustrate, for example, that for a given sensing duty cycle, the FFG approach may have a relatively higher throughput performance gain with respect to the temporal gap approach using the same sensing duty cycle. Using the FFG approach, the sensing detection and evacuation times for a “PU_Assigned” type channel may be reduced when compared to the sensing detection and evacuation times for a temporal gap approach with the same sensing duty cycle.

The processes and instrumentalities described herein may apply in any combination, may apply to other wireless technologies, and for other services.

A WTRU may refer to an identity of the physical device, or to the user's identity such as subscription related identities, e.g., MSISDN, SIP URI, etc. WTRU may refer to application-based identities, e.g., user names that may be used per application.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as CD-ROM disks, and/or digital versatile disks (DVDs). A processor in association with software may be used to implement a radio frequency transceiver for use in a WTRU, UE, terminal, base station, RNC, and/or any host computer.

What is claimed:

1. A method of performing sensing on a portion of a frequency band, the method comprising:
receiving a fractional frequency gap (FFG) pattern indicating a sub-band of the frequency band and an associated time interval;
performing sensing on the sub-band during the time interval indicated by the FFG pattern; and
sending a measurement report comprising a sub-band identifier identifying the sub-band and a sensing metric indicating a metric value corresponding to the sub-band identifier.

2. The method of claim 1, wherein the FFG pattern comprises an enhanced physical data control channel (ePDCCH).

3. The method of claim 1, wherein the FFG pattern comprises a sequence of sub-bands of the frequency band and respective associated time intervals.

4. The method of claim 1, further comprising performing sensing on a sub-band based on an instantaneous channel quality of the sub-band.

5. The method of claim 1, further comprising performing sensing on the sub-band in a deterministic mode in response to receiving an event report indicating a metric value between a first threshold and a second threshold.

6. The method of claim 1, wherein the FFG pattern indicates a plurality of physical resource blocks (PRBs) of the frequency band.

7. The method of claim 6, wherein the FFGs span a control orthogonal frequency division multiplexing (OFDM) symbol, and wherein the PRBs spanning the control OFDM symbol are reinserted in a data OFDM symbol.

8. The method of claim 1, wherein the measurement report further comprises an event report indicating whether a metric exceeds or falls below a threshold value.

9. The method of claim 1, further comprising receiving an FFG type indicating a sub-band sensing type comprising at least one of a deterministic type, an opportunistic type, or a hybrid type.

10. The method of claim 1, further comprising transmitting on an active sub-band near the silenced sub-band with a reduced power level.

11. The method of claim 1, further comprising receiving a filter type indicating a sub-band spectral filter type.

12. The method of claim 1, further comprising receiving a filter type indicating a sub-band guard band filter type.

13. A wireless transmit/receive unit (WTRU) comprising a processor configured to:
receive a fractional frequency gap (FFG) pattern indicating a sub-band of a frequency band and an associated time interval;
perform sensing on the sub-band during the time interval indicated by the FFG pattern; and
send a measurement report comprising a sub-band identifier identifying the sub-band and a sensing metric indicating a metric value corresponding to the sub-band identifier.

14. The WTRU of claim 13, wherein the FFG pattern comprises an enhanced physical data control channel (ePDCCH).

15. The WTRU of claim 13, wherein the FFG pattern comprises a sequence of sub-bands of the frequency band and respective associated time intervals.

16. The WTRU of claim 13, wherein the processor is configured to perform sensing on a sub-band based on an instantaneous channel quality of the sub-band.

17. The WTRU of claim 13, wherein the processor is configured to perform sensing on the sub-band in a deterministic mode in response to receiving an event report indicating a metric value between a first threshold and a second threshold.

18. The WTRU of claim 13, wherein the FFG pattern indicates a plurality of physical resource blocks (PRBs) of the frequency band.

19. The WTRU of claim 18, wherein the FFGs span a control orthogonal frequency division multiplexing (OFDM) symbol, and wherein the PRBs spanning the control OFDM symbol are reinserted in a data OFDM symbol.

20. The WTRU of claim 13, wherein the measurement report further comprises an event report indicating whether a metric exceeds or falls below a threshold value.

21. The WTRU of claim 13, wherein the processor is configured to receive an FFG type indicating a sub-band sensing type comprising at least one of a deterministic type, an opportunistic type, or a hybrid type.

22. The WTRU of claim 13, wherein the processor is configured to transmit on an active sub-band near the silenced sub-band with a reduced power level.

23. The WTRU of claim 13, wherein the processor is configured to receive a filter type indicating a sub-band spectral filter type.

24. The WTRU of claim 13, wherein the processor is configured to receive a filter type indicating a sub-band guard band filter type.

25. An eNodeB comprising a processor configured to:
select fractional frequency gap (FFG) patterns indicating sub-bands of a frequency band and respective associated time intervals; and
sequentially silence the sub-bands during the time intervals indicated by the FFG patterns.

26. The eNodeB of claim 25, wherein the processor is configured to select the FFG patterns as a function of at least one of a type of a primary user or a type of a secondary user operating in the frequency band.

27. The eNodeB of claim 25, wherein the processor is configured to select a length of an FFG to accommodate a narrow band secondary user during a measurement gap.
